(19) United States
(12) Patent Application Publication
(10) Pub. No.: US 2024/0323124 A1
(43) Pub. Date: Sep. 26, 2024

(54) Reactive Sub-Flow Spraying For Load Balancing

(71) Applicant: Microsoft Technology Licensing, LLC, Redmond, WA (US)

(72) Inventors: Abdul KABBANI, Menlo Park, CA (US); Prashant RANJAN, San Jose, CA (US)

(21) Appl. No.: 18/125,101

(22) Filed: Mar. 22, 2023

(51) Int. Cl. H04L 47/125; H04L 43/0864

(52) U.S. Cl. CPC H04L 47/125; H04L 43/0864

(57) ABSTRACT

A method includes dividing a flow of packets between two endpoints into multiple sub-flows and assigning each sub-flow a different hash seed. Packets from the sub-flows are transmitted over a network and performance for each sub-flow is monitored. The hash seed of an underperforming first sub-flow is replaced with a new hash seed based on a performance status of the first sub-flow.

### BACKGROUND

Many different strategies may be used to route data packets in networks. Equal-cost multi-path routing (ECMP) routes packets over multiple network paths between endpoints with equal routing priority. Multi-path routing can be used in conjunction with most routing protocols because it is a per-hop local decision made independently at each router. The use of ECMP can substantially increase bandwidth by load-balancing traffic over multiple paths.

Equal-cost multi-path routing (ECMP) enables oblivious path selection through routers in a multi-path data network based on a hash function H(x), where x is a hash seed that is included in one or more of arbitrary fields in each packet In ECMP, as each router receives a packet, the router looks up a set of possible candidate output ports for a given destination address and then uses H(x) to select one. H(x) is deterministic such that for the same x, the hash function always selects the same output port.

Due to the inherent nature of the output collisions created by the Hash function. ECMP causes imbalance in the distribution of flows amongst the next hop paths available, which results in poor load balancing of traffic in network. This poor load balancing brings down the throughput and efficiency of network significantly.

To achieve better load balancing, packet flows can be broken down into a set of smaller sub-flows and packets of each sub-flow may be spread out or sprayed to multiple different network paths. Spraying of packets may be accomplished by randomizing the hash seed, such as a user datagram protocol (UDP) source address in each packet. In various forms, the path used for each packet may be tracked to identify last known good paths. Variations include limiting the number of paths and tracking bad paths to be avoided.

### SUMMARY

A method includes dividing a flow of packets between two endpoints into multiple sub-flows and assigning each sub-flow a different hash seed. Packets from the sub-flows are transmitted over a network and performance for each sub-flow is monitored. The hash seed of an underperforming first sub-flow is replaced with a new hash seed based on a performance status of the first sub-flow.

### BRIEF DESCRIPTION OF THE DRAWINGS

FIG. 1 is a flowchart illustrating a computer implemented method of load balancing for transmission of packets from a packet flow according to an example embodiment.

FIG. 2 is a flowchart illustrating a method of iteratively replacing the routing hash seeds for underperforming sub-flows according to an example embodiment.

FIG. 3 is a block flow diagram illustrating information transformations during transmission of packet sub-flows according to an example embodiment.

FIG. 4 is a block schematic diagram of a computer system to implement one or more example embodiments.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, logical and electrical changes may be made without departing from the scope of the present invention. The following description of example embodiments is, therefore, not to be taken in a limited sense, and the scope of the present invention is defined by the appended claims.

Equal-cost multi-path routing (ECMP) enables oblivious path selection through routers in a multi-path data network based on a hash function H(x), where x is a hash seed that is included in one or more of arbitrary fields in each packet by an originating endpoint, such as a network interface card (NIC). In ECMP, as each router receives a packet, the router looks up a set of possible candidate output ports for a given destination address and then uses H(x) to select one. H(x) is deterministic such that for the same x, the hash function always selects the same output port.

To achieve better load balancing, packet flows can be broken down into a set of smaller sub-flows and packets of each sub-flow may be spread out or sprayed to multiple different network paths. Spraying of packets may be accomplished by randomizing the hash seed, such as a UDP source address in each packet. While spraying of packets provides a good distribution of packets, some paths may become overloaded, reducing performance of the network. Failed paths can also adversely affect network throughput.

An improved load balancing mechanism divides a packet flow into sub-flows and utilizes a reactive packet sub-flow spray at each source endpoint. A different hash seed is used for each sub-flow. Performance statistics are kept for each sub-flow and poorer performing sub-flows are provided different hash seeds by the originating endpoint. Modifying hash seeds for poorer performing sub-flows provides a spray of packet sub-flows that is reactive to path performance, and automatically accounts for broken paths. The load balancing mechanism moves sub-flows of packets to less congested paths based on feedback from the network and over time converges to a stable operating point with high efficiency and packet throughput.

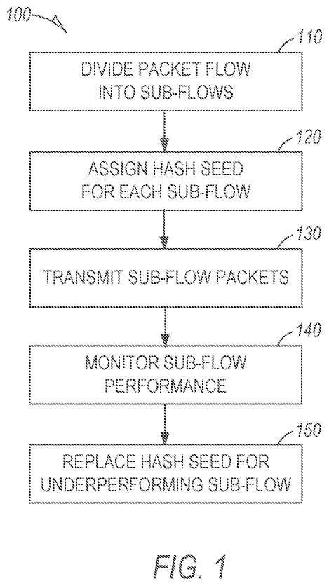

FIG. 1 is a flowchart illustrating a computer implemented method 100 of load balancing for transmission of packets from a packet flow. A packet flow is a flow of data packets from a source endpoint to a destination endpoint via a multi-path network. Example packet flows may be packets containing streaming video or any type of data transfer between two endpoints and can be made up a few to several thousand or more packets.

Method 100 begins at operation 110 by dividing a flow of packets between the two endpoints into multiple sub-flows of packets. In one example, more than two sub-flows are used. The number of sub-flows may be 8 or more in one example. The packets in the packet flow may be assigned to sub-flows in a round robin manner or by simply assigning packets substantially equally between sub-flows in any manner. Assigning in a round robin manner simply assigns the first packet in the flow to the first sub-flow, the second packet in the flow to the second sub-flow and upon reaching the last sub-flow, repeating.

Each sub-flow of packets is assigned a different hash seed at operation 120. The hash seed in an ECMP network is used by each node in the network to determine a path to a next node using a hash function. Packets with the same hash seed result in those packets following the same path through the network. The hash seed in one example is at least 16 bits in length. The size of the hash seed may be varied depending on the strength of the hashing function used at each node/switch/router.

At operation 130, the packets from the sub-flows are transmitted over the network. In one example, the packets are transmitted from the sub-flows in a round robin manner.

Operation 140 monitors performance for each sub-flow. In one example, monitoring performance for each sub-flow comprises tracking round trip times for packets in the sub-flow. In a further example, monitoring performance for each sub-flow comprises tracking information corresponding to at least one of round trip times for packets, number of in-flight packets, number of ECN, or number of Acks.

Tracked information may be stored in a table or other data structure for use in evaluating sub-flow performance. Tracked information for each sub-flow may be aged out such that the tracked information is representative of recent sub-flow performance. Aging out may be done periodically, or simply by using a limited size first in first out queue.

At operation 150, the hash seed of an underperforming sub-flow is replaced with a new hash seed based on the network status of the first sub-flow.

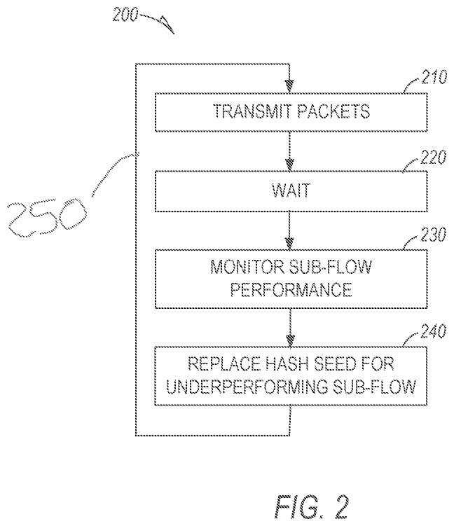

FIG. 2 is a flowchart illustrating a method 200 of iteratively replacing the routing hash seeds for underperforming sub-flows. Method 200 includes operation 210 that transmits packets from the sub-flows over a network following replacement of at least one of the hash seeds due to underperformance of one or more sub-flows. Performance for each sub-flow is monitored at operation 220. After waiting for a selected time period from a previous replacing of a sub-flow hash seed at operation 230, operation 240 replaces the hash seed of an underperforming sub-flow with a new hash seed based on the network status of the first sub-flow. Method 200 iterates by returning to operation 210 as indicated by loop line 250 until the flow is complete.

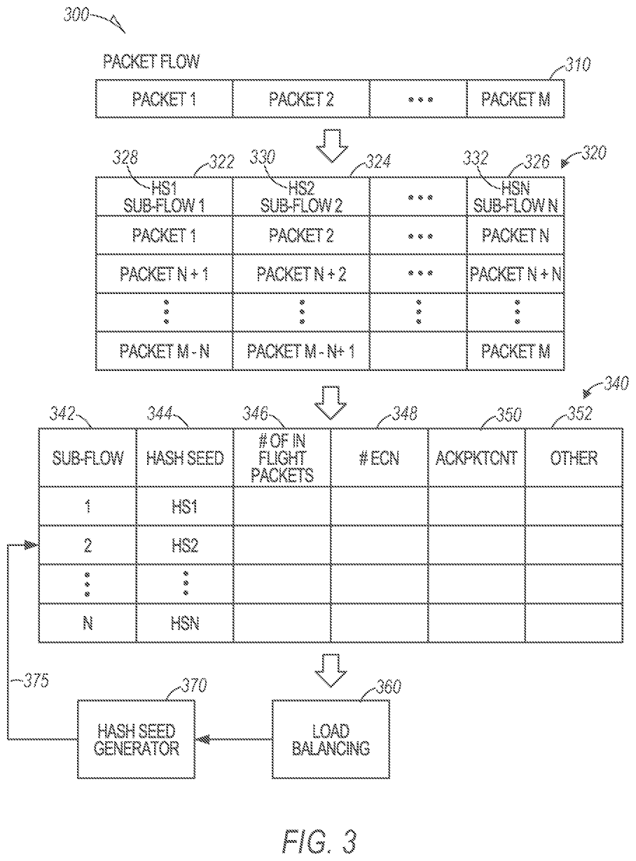

FIG. 3 is a block flow diagram illustrating information transformations during transmission of packet sub-flows generally at 300. A packet flow 310 includes multiple packets shown as PACKET 1, PACKET 2 . . . PACKET M. M can be very large in some packet flows, such as several thousand or more. Packet flow 310 is divided up into sub-flows as shown in table 320, showing SUB-FLOW 1 322, SUB-FLOW 2 324 . . . . SUB-FLOW N 326. N sub-flows are used in one example where N may be any number greater than 1 and is typically 8 or 16 or higher.

Each sub-flow has an initial corresponding hash seed, HS1 328, HS2 330 . . . HSN 332. Packets are assigned to each sub-flow in a round robin order in one example. SUB-FLOW 1 322 includes packet 1, packet N-+1 . . . down to packet M-N. Similarly, SUB-FLOW 2 324 includes packet 2, packet N+2 . . . down to packet M-N+1. SUB-FLOW N 326 includes packet N, packet N+N . . . down to packet M. Note that the last packet, M may reside in any of the sub-flows where M/N has a remainder.

Once the sub-flows are established, a path status table 340 is used to track performance information for each sub-flow. Table 340 includes multiple columns, including a sub-flow identifier column 342 and hash seed 344. A number of congestion fields are used to monitor performance of network with respect to each of the sub-flows. Congestion fields include by are not limited to number of in flight packets 346, number of ECNs (explicit congestion notifications) 348, ACKPKTCNT (acknowledged packet count) 350 and other 352. The congestion fields each contain packet sub-flow performance information.

Table 340 has one row for each sub-flow with a corresponding hash seed 344 currently being used for the sub-flow. For each hash seed, the remaining columns contain various end to end network status feedback signals. The Other column 352 is representative of other types of signals related to network performance for the sub-flow. The hash seeds 344 used in one example are 16 bits wide (such as UDP source ports fields) and are pseudo random.

In one example, the hash seeds may be generated the first time a packet from a sub-flow is to be sent, and added to the packet. Information in the congestion fields may be aged out periodically (one way could be to decrement the value by 1 periodically) using a configurable Time window.

A load balancing mechanism 360 is used to compare one or more pieces of information from the congestion fields to an acceptable threshold. Anytime, a particular sub-flow has congestion field information that exceeds the acceptable threshold or set of rules, an algorithm, or policy, a new hash seed for the sub-flow is generated at 370 and used to replace the hash seed for that sub-flow as indicated at 375. The new hash seed may be randomly generated in one example.

The initial hash seeds shown in table 340 may be randomly generated and assigned. As the hash seeds result in each switch in the network selecting a next hop in a path, the distribution of packets may not be ideal, and some paths may or will have oversubscription. As congestion information is received and monitored, it provides feedback regarding the performance of the network for each sub-flow. The feedback results in re-distributing sub-flows, which over time, we will result in a uniform distribution for a particular flow/connection. The latency might be high at the start of a flow, but the reactive load balancing will achieve steady state over time as a result of replacing poor performing sub-flows.

An example pseudocode listing is shown below. In a first section, parameters are set, including a parameter maxR for setting a maximum number of sub-flows to be rerouted at a time. A value of 1 is used in the example, but may be any integer that is less than the total number of sub-flows for a flow. Higher values may make it difficult for convergence to occur, so values of between 1 and 2 are likely to be used for 8 sub-flows.

A cooloff parameter is 25 in the example listing. The cooloff parameter specifies how many packets from each sub-flow to send. In one example, the cooloff period may be random with a maximum value of 25.

A RRThr parameter is set to 2.0 in the example listing. This parameter is a congestion factor that is used to determine if a sub-flow is contested and may be subject to having its hash value replaced.

A next section of the list describes performance variables corresponding to information regarding the performance of sub-flows that is later used to determine whether or not to replace a hash seed for a given sub-flow. This section includes two performance variables for each sub-flow including an in flight packet count for the sub-flow and a number of acknowledgements count. Congestion is defined as a combination of the two exceeding the RRThr parameter. This is done only if not still in the cool off state.

Once the cool off state ends, the table 320, referred to in the list as path state table (PST) is scanned and one or more sub-flows are rerouted in accordance with the specified maxR parameter, which is 1 in this example. The performance variables in the table are then cleared in order to begin collecting performance data based that changed due to the changed hash seed for the lowest performing sub-flow. A random cool off period is then calculated and the another under performing sub-flow may have its hash seed replaced.

Pseudocode Listing:

P _maxR = 1; I I max. number of sub flows to be rerouted at a time
P _cooloff= 25; I I max. random cool off period (no more rerouting) after
reroute
P _RRThr = 2.0; II congestion factor to determine if sub-flowlpath is
congested
II sub flow congestion markers
sub-flowCFlf = inFlightPktCnt I ackCnt;
congested = (ecnCnt != 0) && (sub-flowCFlf > P _RRThr);
For all connections j:
if (not in Cooloff state)
I I scan the Path State Table (PST) for high congested paths and reroute
if eligible
for all sub flows:
P _thr = 0 + (entropy & 15) I I probability generated on the fly
if (congested)
CC tracker++;
if ((numFlowRerouted[j] < P _maxR) && (CCtracker > = P _thr))
numFlowRerouted[j]++; II reroute
else
CCtracker = 0;
I I clear sampling window-based counters
For all sub flows:
ackCnt = 0;
ecnCnt = 0;
txPktCnt = 0;
II random backoff for all rerouted sub flows
For all rerouted connections:
cool off for rand(P cooloff);

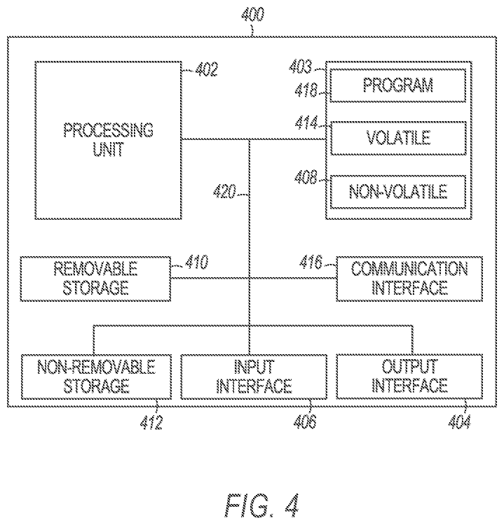

FIG. 4 is a block schematic diagram of a computer system 400 to implement reactive sub-flow spraying in originating endpoints, router or switch operations, and for performing methods and algorithms according to example embodiments. All components need not be used in various embodiments.

One example computing device in the form of a computer 400 may include a processing unit 402, memory 403, removable storage 410, and non-removable storage 412. Although the example computing device is illustrated and described as computer 400, the computing device may be in different forms in different embodiments. For example, the computing device may instead be a smartphone, a tablet, smartwatch, smart storage device (SSD), or other computing device including the same or similar elements as illustrated and described with regard to FIG. 4. Devices, such as smartphones, tablets, and smartwatches, are generally collectively referred to as mobile devices or user equipment.

Although the various data storage elements are illustrated as part of the computer 400, the storage may also or alternatively include cloud-based storage accessible via a network, such as the Internet or server-based storage. Note also that an SSD may include a processor on which the parser may be run, allowing transfer of parsed, filtered data through I/O channels between the SSD and main memory.

Memory 403 may include volatile memory 414 and non-volatile memory 408. Computer 400 may include or have access to a computing environment that includes—a variety of computer-readable media, such as volatile memory 414 and non-volatile memory 408, removable storage 410 and non-removable storage 412. Computer storage includes random access memory (RAM), read only memory (ROM), erasable programmable read-only memory (EPROM) or electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions.

Computer 400 may include or have access to a computing environment that includes input interface 406, output interface 404, and a communication interface 416. Output interface 404 may include a display device, such as a touchscreen, that also may serve as an input device. The input interface 406 may include one or more of a touchscreen, touchpad, mouse, keyboard, camera, one or more device-specific buttons, one or more sensors integrated within or coupled via wired or wireless data connections to the computer 400, and other input devices. The computer may operate in a networked environment using a communication connection to connect to one or more remote computers, such as database servers. The remote computer may include a personal computer (PC), server, router, network PC, a peer device or other common data flow network switch, or the like. The communication connection may include a Local Area Network (LAN), a Wide Area Network (WAN), cellular, Wi-Fi, Bluetooth, or other networks. According to one embodiment, the various components of computer 400 are connected with a system bus 420.

Computer-readable instructions stored on a computer-readable medium are executable by the processing unit 402 of the computer 400, such as a program 418. The program 418 in some embodiments comprises software to implement one or more methods described herein. A hard drive, CD-ROM, and RAM are some examples of articles including a non-transitory computer-readable medium such as a storage device. The terms computer-readable medium, machine readable medium, and storage device do not include carrier waves or signals to the extent carrier waves and signals are deemed too transitory. Storage can also include networked storage, such as a storage area network (SAN). Computer program 418 along with the workspace manager 422 may be used to cause processing unit 402 to perform one or more methods or algorithms described herein.

### EXAMPLES

1. A method includes dividing a flow of packets between two endpoints into multiple sub-flows and assigning each sub-flow a different hash seed. Packets from the sub-flows are transmitted over a network and performance for each sub-flow is monitored. The hash seed of an underperforming first sub-flow is replaced with a new hash seed based on a performance status of the first sub-flow.

2 The method of example 1 and further including following replacing the hash seed, transmitting packets from the sub-flows over a network, monitoring performance for each sub-flow, waiting for a selected time period from a previous replacing of a sub-flow hash seed, and replacing the hash seed of an underperforming sub-flow with a new hash seed based on the network status of the first sub-flow.

3 The method of any of examples 1-2 wherein monitoring performance for each sub-flow includes tracking round trip times for packets in each ub-flow.

4. The method of any of examples 1-3 wherein monitoring performance for each sub-flow includes tracking information corresponding to at least one of round trip times for packets, number of in-flight packets, number of ECN, or number of Acks.

5. The method of example 4 wherein monitoring performance for each sub-flow includes aging out tracked information such that the tracked information is representative of recent sub-flow performance.

6. The method of any of examples 1-5 w herein the multiple sub-flows include eight or more sub-flows.

7. The method of any of examples 1-6 wherein the hash seed is 16 bits or more and is randomly generated.

8. The method of any of examples 1-7 wherein packets are transmitted for the sub-flows in a round robin manner.

9. The method of any of examples 1-8 wherein packets in the packet flow are assigned to sub-flows in a round robin manner.

10. A machine-readable storage device has instructions for execution by a processor of a machine to cause the processor to perform operations to perform a method, the operations including dividing a flow of packets between two endpoints into multiple sub-flows, assigning each sub-flow a different hash seed, transmitting packets from the sub-flows over a network, monitoring performance for each sub-flow, and replacing the hash seed of an underperforming first sub-flow with a new hash seed based on a performance status of the first sub-flow.

11. The device of example 10 wherein following replacing the hash seed, the operations include transmitting packets from the sub-flows over a network, monitoring performance for each sub-flow, waiting for a selected time period from a previous replacing of a sub-flow hash seed, and replacing the hash seed of an underperforming sub-flow with a new hash seed based on the network status of the first sub-flow.

12. The device of any of examples 10-11 wherein monitoring performance for each sub-flow comprises tracking information corresponding to at least one of round trip times for packets, number of in-flight packets, number of ECN, or number of Acks.

13. The device of example 12 wherein monitoring performance for each sub-flow includes aging out tracked information such that the tracked information is representative of recent sub-flow performance.

14 The device of any of examples 10-13 wherein the multiple sub-flows include eight or more sub-flows and wherein the hash seed is 16 bits or more and is randomly generated.

15. The device of any of examples 10-14 wherein packets are transmitted for the sub-flows in a round robin manner and packets in the packet flow are assigned to sub-flows in a round robin manner.

16. A device includes a processor and a memory device coupled to the processor and having a program stored thereon for execution by the processor to perform operations including dividing a flow of packets between two endpoints into multiple sub-flows, assigning each sub-flow a different hash seed, transmitting packets from the sub-flows over a network, monitoring performance for each sub-flow, and replacing the hash seed of an underperforming first sub-flow with a new hash seed based on a performance status of the first sub-flow.

17. The device of example 16 wherein following replacing the hash seed, the operations include transmitting packets from the sub-flows over a network, monitoring performance for each sub-flow, waiting for a selected time period from a previous replacing of a sub-flow hash seed, and replacing the hash seed of an underperforming sub-flow with a new hash seed based on the network status of the first sub-flow.

18. The device of any of examples 16-17 wherein monitoring performance for each sub-flow includes tracking information corresponding to at least one of round trip times for packets, number of in-flight packets, number of ECN, or number of Acks.

19. The device of example 18 wherein monitoring performance for each sub-flow includes aging out tracked information such that the tracked information is representative of recent sub-flow performance.

20. The device of any of examples 16-19 wherein the multiple sub-flows include eight or more sub-flows and wherein the hash seed is 16 bits or more and is randomly generated.

The functions or algorithms described herein may be implemented in software in one embodiment. The software may consist of computer executable instructions stored on computer readable media or computer readable storage device such as one or more non-transitory memories or other type of hardware-based storage devices, either local or networked. Further, such functions correspond to modules, which may be software, hardware, firmware or any combination thereof. Multiple functions may be performed in one or more modules as desired, and the embodiments described are merely examples. The software may be executed on a digital signal processor, ASIC, microprocessor, or other type of processor operating on a computer system, such as a personal computer, server or other computer system, turning such computer system into a specifically programmed machine.

The functionality can be configured to perform an operation using, for instance, software, hardware, firmware, or the like. For example, the phrase “configured to” can refer to a logic circuit structure of a hardware element that is to implement the associated functionality. The phrase “configured to” can also refer to a logic circuit structure of a hardware element that is to implement the coding design of associated functionality of firmware or software. The term “module” refers to a structural element that can be implemented using any suitable hardware (e.g., a processor, among others), software (e.g., an application, among others), firmware, or any combination of hardware, software, and firmware. The term, “logic” encompasses any functionality for performing a task. For instance, each operation illustrated in the flowcharts corresponds to logic for performing that operation. An operation can be performed using, software, hardware, firmware, or the like. The terms, “component,” “system,” and the like may refer to computer-related entities, hardware, and software in execution, firmware, or combination thereof. A component may be a process running on a processor, an object, an executable, a program, a function, a subroutine, a computer, or a combination of software and hardware. The term, “processor,” may refer to a hardware component, such as a processing unit of a computer system.

Furthermore, the claimed subject matter may be implemented as a method, apparatus, or article of manufacture using standard programming and engineering techniques to produce software, firmware, hardware, or any combination thereof to control a computing device to implement the disclosed subject matter. The term, “article of manufacture,” as used herein is intended to encompass a computer program accessible from any computer-readable storage device or media. Computer-readable storage media can include, but are not limited to, magnetic storage devices, e.g., hard disk, floppy disk, magnetic strips, optical disk, compact disk (CD), digital versatile disk (DVD), smart cards, flash memory devices, among others. In contrast, computer-readable media, i.e., not storage media, may additionally include communication media such as transmission media for wireless signals and the like.

Although a few embodiments have been described in detail above, other modifications are possible. For example, the logic flows depicted in the figures do not require the particular order shown, or sequential order, to achieve desirable results. Other steps may be provided, or steps mas be eliminated, from the described flows, and other components may be added to, or removed from, the described systems. Other embodiments may be within the scope of the following claims.

1. A method comprising:
dividing a flow of packets between two endpoints into multiple sub-flows;
assigning each sub-flow a different hash seed;
transmitting packets from the sub-flows over a network;
monitoring performance for each sub-flow; and
replacing the hash seed of an underperforming first sub-flow with a new hash seed based on a performance status of the first sub-flow.

2. The method of claim 1 and further comprising following replacing the hash seed:
transmitting packets from the sub-flows over a network;
monitoring performance for each sub-flow;
waiting for a selected time period from a previous replacing of a sub-flow hash seed; and
replacing the hash seed of an underperforming sub-flow with a new hash seed based on the network status of the first sub-flow.

3. The method of claim 1 wherein monitoring performance for each sub-flow comprises tracking round trip times for packets in each ub-flow.

4. The method of claim 1 wherein monitoring performance for each sub-flow comprises tracking information corresponding to at least one of round trip times for packets, number of in-flight packets, number of ECN, or number of Acks.

5. The method of claim 4 wherein monitoring performance for each sub-flow comprises aging out tracked information such that the tracked information is representative of recent sub-flow performance.

6. The method of claim 1 wherein the multiple sub-flows comprise eight or more sub-flows.

7. The method of claim 1 wherein the hash seed is 16 bits or more and is randomly generated.

8. The method of claim 1 wherein packets are transmitted for the sub-flows in a round robin manner.

9. The method of claim 1 wherein packets in the packet flow are assigned to sub-flows in a round robin manner.

10. A machine-readable storage device having instructions for execution by a processor of a machine to cause the processor to perform operations to perform a method, the operations comprising:
dividing a flow of packets between two endpoints into multiple sub-flows;
assigning each sub-flow a different hash seed;
transmitting packets from the sub-flows over a network;
monitoring performance for each sub-flow; and
replacing the hash seed of an underperforming first sub-flow with a new hash seed based on a performance status of the first sub-flow.

11. The device of claim 10 wherein following replacing the hash seed, the operations include:
transmitting packets from the sub-flows over a network;
monitoring performance for each sub-flow;
waiting for a selected time period from a previous replacing of a sub-flow hash seed; and
replacing the hash seed of an underperforming sub-flow with a new hash seed based on the network status of the first sub-flow.

12. The device of claim 10 wherein monitoring performance for each sub-flow comprises tracking information corresponding to at least one of round trip times for packets, number of in-flight packets, number of ECN, or number of Acks.

13. The device of claim 12 wherein monitoring performance for each sub-flow comprises aging out tracked information such that the tracked information is representative of recent sub-flow performance.

14. The device of claim 10 wherein the multiple sub-flows comprise eight or more sub-flows and wherein the hash seed is 16 bits or more and is randomly generated.

15. The device of claim 10 wherein packets are transmitted for the sub-flows in a round robin manner and packets in the packet flow are assigned to sub-flows in a round robin manner.

16. A device comprising:
a processor; and
a memory device coupled to the processor and having a program stored thereon for execution by the processor to perform operations comprising:
dividing a flow of packets between two endpoints into multiple sub-flows;
assigning each sub-flow a different hash seed;
transmitting packets from the sub-flows over a network;
monitoring performance for each sub-flow; and
replacing the hash seed of an underperforming first sub-flow with a new hash seed based on a performance status of the first sub-flow.

17. The device of claim 16 wherein following replacing the hash seed, the operations include:
transmitting packets from the sub-flows over a network;
monitoring performance for each sub-flow;
waiting for a selected time period from a previous replacing of a sub-flow hash seed; and
replacing the hash seed of an underperforming sub-flow with a new hash seed based on the network status of the first sub-flow.

18. The device of claim 16 wherein monitoring performance for each sub-flow comprises tracking information corresponding to at least one of round trip times for packets, number of in-flight packets, number of ECN, or number of Acks.

19. The device of claim 18 wherein monitoring performance for each sub-flow comprises aging out tracked information such that the tracked information is representative of recent sub-flow performance.

20. The device of claim 16 wherein the multiple sub-flows comprise eight or more sub-flows and wherein the hash seed is 16 bits or more and is randomly generated.
